(19) United States
(12) Patent Application Publication
(10) Pub. No.: US 2026/0127006 A1
(43) Pub. Date: May 7, 2026

(54) SYSTEM AND METHOD FOR THE CENTRALIZED MANAGEMENT OF DISTRIBUTED INTERMITTENTLY CONNECTED RUNTIME PLATFORMS

(71) Applicant: Raft LLC, McLean, VA (US)

(72) Inventors: Dagan Henderson, Rocklin, CA (US); Dane Curran, Fredericksburg, VA (US); Daniel Morrison, Vestavia, AL (US); James Baker, Glen Mills, PA (US)

(21) Appl. No.: 19/350,573

(22) Filed: Oct. 6, 2025

Related U.S. Application Data
(60) Provisional application No. 63/714,890, filed on Nov. 1, 2024.

(51) Int. Cl. G06F 9/4401

(52) U.S. Cl. CPC G06F 9/4401

(57) ABSTRACT

A system and method for the centralized management of distributed intermittently connected runtime platforms. The method may include creating an artifact store pre-loaded with a set of utilities, libraries, and artifacts necessary to perform initial infrastructure creation in a local environment, creating an instance infrastructure for a central management system, and creating two or more availability zones, wherein each availability zone includes a private subnet and a public subnet. The method may further include transferring state data necessary to perform infrastructure as code (IaC) automation from the local environment to the artifact store.

### CROSS-REFERENCE TO RELATED APPLICATIONS

This application claims the benefit of U.S. provisional application 63/714,890, which was filed on Nov. 1, 2025 the contents of which is hereby incorporated by reference in its entirety.

### DISCUSSION OF THE RELATED ART

Runtime platforms may provide tenant computer programs with an execution environment and supporting services, such as orchestration and scheduling of computer program executions, network service discovery, identity, credential and account management (ICAM), network traffic management, data storage and persistence, audit and application log aggregation, monitoring and observability, and security and compliance scanning, alerting, and enforcement. These platforms may be deployed to a single computing device, or a collection of multiple devices providing distributed compute resources, and may be installed in data centers intended for global user availability (in-cloud), co-located with a userbase or tightly coupled system (on-premises), or mobile (edge).

The individual management of multiple platforms may pose a significant administrative burden, making centralized management a valuable and important solution, especially in disconnected, denied, intermittent, and limited-bandwidth (DDIL) environments. When managing platforms distributed across in-cloud, on-premises, and/or edge installations, existing centralized management systems may depend on reliable connectivity between the centralized systems and distributed platforms. If connectivity is lost, the operational stability of the runtime platform may be jeopardized, impacting tenant program availability and risking data corruption and/or loss.

### SUMMARY OF DISCLOSURE

In one example implementation, a computer-implemented method executed on a computing device may include creating an artifact store pre-loaded with a set of utilities, libraries, and artifacts necessary to perform initial infrastructure creation in a local environment, creating a bootstrapping instance infrastructure for a central management system, and creating two or more availability zones, where each availability zone includes a private subnet and a public subnet. The method may further include transferring state data necessary to perform infrastructure as code (IaC) automation from the local environment to the artifact store.

One or more of the following example features may be included. The method may further include, performing initial configuration of the central management system, and creating a secondary management system from the central management system via IaC and one or more automation pipelines. The method may also include transferring management of the central management system to the secondary management system, and creating and managing distributed tenant platforms through the central management system. If the local environment is a hosted-server, then creating the bootstrapping instance infrastructure may include creating the set of administrator identities and permission policies through a hosted user-interface, creating a bootstrapping network with at least one of internet access, or private cloud-provider endpoint connections to a set of application programming interfaces (API) endpoints used to create the central management system infrastructure, creating a bootstrap bastion and assigning the set of administrator identities and permission policies to the bootstrap bastion, and transferring the artifact store contents to the bootstrap bastion. If the local environment is a dedicated workstation, then creating the bootstrapping instance infrastructure may include preloading the dedicated workstation with a first set of utilities, libraries, and artifacts necessary to perform the initial infrastructure creation, performing initial infrastructure creation using infrastructure-as-code (IaC) based automation, and securely transferring a second set of infrastructure management API keys and/or credentials to the dedicated workstation. Performing initial configuration of the central management system may further include deploying, via the bootstrap bastion, a first set of application images including at least a network driver, a storage driver, an ingress gateway, and an internal artifact store directly to each cluster of network nodes, copying a second set of application images for later use by the central management system to the artifact store, and deploying, via the bootstrap bastion, any remaining system components including at least an identity provider, a source control repository, a continuous integration automation system, a secrets manager, an automated application deployment system, a service mesh, a policy agent, a vulnerability scanner, and time-series and log observability systems. The computer-implemented method may further include performing initial configuration of a first identity, credential, and account management (ICAM) system, performing initial configuration of a first centralized identity management system, performing initial configuration of external authentication for an infrastructure provider, and decommissioning the bootstrapping instance infrastructure. The ICAM system may be configured to initially require mutual transport layer security (mTLS) connections, including client certificates signed by a trusted certificate authority, before allowing access, and a built-in administrator account is initially provided to the ICAM by a secret management system. During initial configuration, all systems may be configured using the built-in administrator credentials provided via the secret management system, where, after the ICAM system is configured, the built-in administrator account may be configured to set up single sign-on access via the ICAM system, and then the built-in administrator accounts may be disabled. The ICAM system may be configured to provide authentication access to an infrastructure's API endpoints and user interface. The ICAM system may be configured to allow automation pipelines requesting temporary credentials for the infrastructure provider to enable secure automated management of infrastructure via the automation pipelines. Before decommissioning the bootstrap bastion all infrastructure as code (IaC), libraries, and tools may be transferred over to the artifact store before decommissioning the bootstrap bastion. Creating a secondary management system from the central management system may further include creating two or more secondary availability zones, wherein each secondary availability zone includes a private subnet, and a public subnet, for each private subnet, creating a secondary cluster of network nodes and a load balancer, for each private subnet, creating a secondary control plane configured to manage connections to the cluster of networked nodes, for each private subnet, creating a secondary temporary bootstrap bastion and assigning a second set of administrator identities and permission policies to administer the cluster of networked nodes, and transferring state data necessary to perform IaC automation to a secondary artifact store. The computer-implemented method may further include creating one or more internal service endpoints to operatively connect a first set of components from the central management system, including at least infrastructure API endpoints, artifact stores, and secret managers, to a corresponding set of components in the secondary management system, performing initial configuration of a secondary identity, credential, and account management (ICAM) system, and performing initial configuration of a secondary centralized identity management system. Application images for the secondary management system deployed may be via the automated application deployment system of the central management system, and where the images served by the artifact store of the central management system may be provided by the secret manager of the central management system. After the secondary ICAM system is configured, a built-in administrator account may be used to configure single sign-on via the secondary ICAM system, and then the built-in administrator accounts may be disabled. Transferring management of the central management system to the secondary management system may include using a secondary automated application deployment system from the secondary management system to manage each subsystem of the central management system, transferring IaC state data for the central management system to the secondary management system, and creating one or more secondary automation pipelines to automate future infrastructure. Creating and managing distributed tenant platforms through the central management system may include installing a firewall configured to create and manage virtual subnets at a tenant system location, establishing a virtual private network tunnel between the tenant system location and the central management system, and creating a management bastion configured to act as an agent of an integration automation system of the central management system, creating identities and permission policies for managing tenant-location infrastructure and storing them in the secrets manager of the central management system, creating one or more IaC repositories in the central management system and one or more integration pipelines to apply the IaC using credentials securely retrieved from the secrets manager of the central management system, creating a cluster of control plane nodes, via the integration pipelines, preloaded with application images from the control plane component and creating a cluster of worker nodes preloaded with application images from the secondary artifact store, pushing a plurality of application images from the control plane to the secondary artifact store, creating and transferring administrator credentials and permission policies to the secrets manager of the central management system, deploying a plurality of components from the application deployment system central management system's using credentials securely provided by the secrets manager, and adding tenant applications to the cluster of control plane nodes via the integration pipelines configured to push application images to the secondary artifact store of cluster of worker nodes and deploying the applications via the application deployment system of the central management system. The integration pipelines may be executed from an agent on the management bastion to enable the centralized management of edge infrastructure.

In another example implementation, a centralized management system for distributed intermittently connected runtime platforms may include an artifact store pre-loaded with a set of utilities, libraries, and artifacts necessary to perform initial infrastructure creation, a primary management system deployed on a hosted server, and configured to manage and control a plurality of runtime platforms, where the primary management system includes two or more availability zones, and each availability zone includes a private subnet and a public subnet. The centralized management system may also include a secondary management system operatively connected to the primary management system, and configured to manage and control the primary management system, where the secondary management system may be further configured to ensure continuity of command and control in the event of a loss or disruption of the primary management system, and where the secondary management system may be configured to recover and replace the primary management system via autonomous methods and automated routines.

One or more of the following example features may be included. The primary management system may be further configured to store and execute automated routines that create, initialize, and monitor platform infrastructure for one or more connected runtime platforms, and deploy, initialize, and monitor a combination of services, tenant applications and security systems hosted on the one or more runtime platforms.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 diagrammatically depicts a management process coupled to a distributed computing network consistent with embodiments of the present disclosure;

FIG. 2 is an example flowchart of the management process of FIG. 1 consistent with embodiments of the present disclosure;

FIG. 3 is an example of a hosted-infrastructure-based bootstrap configuration consistent with embodiments of the present disclosure;

FIGS. 4A-B are example flowcharts of bootstrap instance creation processes according to the management process of FIG. 2;

FIG. 5 is an example of a hosted-infrastructure-based bootstrap configuration with a central management system consistent with embodiments of the present disclosure;

FIG. 6 is an example flowchart of the initial configuration process for the central management system according to the management process of FIG. 2;

FIG. 7 is an example of a hosted-infrastructure-based bootstrap configuration with a central management system and a secondary management system consistent with embodiments of the present disclosure;

FIG. 8 is an example flowchart of the initial configuration process for the secondary management system according to the management process of FIG. 2;

FIG. 9 is an example flowchart of the management transfer process between the central management system and the secondary management system according to the management process of FIG. 2;

FIG. 10 is an example of a central management system creating and managing on-premises tenant platforms consistent with embodiments of the present disclosure;

FIG. 11 is an example of a central management system and a secondary management system creating and managing distributed tenant platforms consistent with embodiments of the present disclosure;

FIG. 12 is an example flowchart of the distributed tenant platform creation process according to the management process of FIG. 2; and

FIG. 13 is an example of an identity, credential, and account management (ICAM) sub-system consistent with embodiments of the present disclosure.

### DETAILED DESCRIPTION

Described herein may be systems, methods, and computer program products for the centralized management of distributed intermittently connected runtime platforms. A high-availability pair of management systems may provide centrally available autonomous and user-driven services for the creation and management of distributed runtime platforms and their associated services, tenant programs, user and service identities, and data storage and persistence. Administrators may establish connectivity between a remote site and the centralized environment, then may invoke automated routines in the centralized management system to create and configure the distributed runtime platform and its services. Systems and computer programs required for operational stability of tenant applications may be deployed to or co-located with the distributed platform and maintain best-effort connectivity with the centralized management systems to enable remote management, configuration, and monitoring. Tenant programs may be initially deployed from the centralized management system but ultimately orchestrated by the host runtime platform and supported by its internal or co-located systems, ensuring that tenant program dependencies remain available when disconnected from the centralized management system. Identity, credential, and account management systems (IdAM/ICAM) may be centrally managed but distributed to each runtime platform to enable authentication, security, and compliance scanning, alerting, and enforcement systems that may be deployed to or co-located with the runtime platform. Automated enforcement may be configured by and observable from the centralized management system, but may not rely on connectivity for autonomous operations.

There may be a need for methods and systems to enable centralized management of runtime platforms, their services, and their tenant computer programs, including the management and monitoring of each, that retains operational stability and data integrity of the managed runtime platforms, their services, and their tenant computer programs during periods of degraded or lost network connectivity. The components of the invention may include: a primary and secondary management system; an independent orchestration system for each runtime platform instance; a service discovery and network traffic management system for each runtime platform instance; a centrally managed identity, credential and account management system with identity subsystems distributed with each runtime platform instance; centrally managed independent data storage and persistence systems distributed with each runtime platform instance; centrally managed independent security, compliance and alerting systems distributed with each runtime platform instance; centrally managed observability systems with centrally cascading alerting, logging and metrics data; an infrastructure-specific bootstrapping and low-level management system.

Reference will now be made in detail to the embodiments of the present disclosure, examples of which are illustrated in the accompanying drawings. The present disclosure may, however, be embodied in many different forms and should not be construed as being limited to the embodiments set forth herein. Rather, these embodiments are provided so that this disclosure will be thorough and complete, and will fully convey the concept of the disclosure to those skilled in the art.

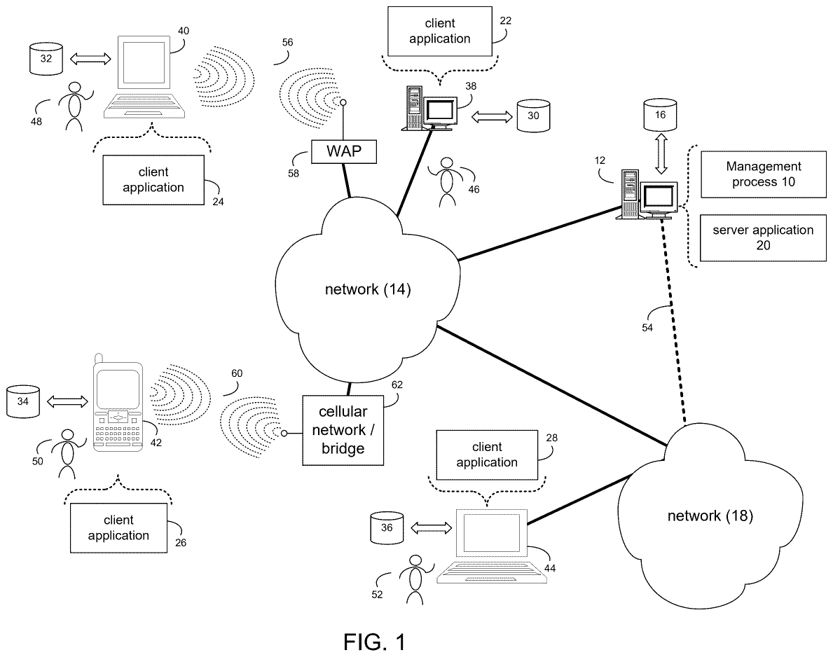

Referring to FIG. 1, there is shown a management process 10 that may reside on and may be executed by server computer 12, which may be connected to network 14 (e.g., the internet or a local area network). Examples of server computers 12 may include, but are not limited to: a personal computer, a server computer, a series of server computers, a minicomputer, and a mainframe computer. Server computer 12 may be a web server (or a series of servers) running a network operating system, examples of which may include but are not limited to: Microsoft Windows XP Server™; Novell Netware™; or Redhat Linux™, for example. Additionally, and/or alternatively, management process 10 may reside on a client electronic device, such as a personal computer, notebook computer, personal digital assistant, or the like.

The instruction sets and subroutines of the management process 10, which may be stored on storage device 16 coupled to server computer 12, may be executed by one or more processors (not shown) and one or more memory architectures (not shown) incorporated into server computer 12. Storage device 16 may include, but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, which allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more server applications (e.g., server application 20), examples of which may include but are not limited to, e.g., Microsoft Exchange^{tm} Server, etc. Server application 20 may interact with one or more client applications (e.g., client applications 22, 24, 26, 28) in order to execute management process 10. Examples of client applications 22, 24, 26, 28 may include, but are not limited to, EDAs or design verification tools such as those available from the assignee of the present disclosure. These applications may also be executed by server computer 12. In some embodiments, management process 10 may be a stand-alone application that interfaces with server application 20 or may be applets/applications that may be executed within server application 20.

The instruction sets and subroutines of server application 20, which may be stored on storage device 16 coupled to server computer 12, may be executed by one or more processors (not shown) and one or more memory architectures (not shown) incorporated into server computer 12.

As mentioned above, in addition, or as an alternative to being server-based applications residing on server computer 12, management process 10 may be a client-side application residing on one or more client electronic devices 38, 40, 42, 44 (e.g., stored on storage devices 30, 32, 34, 36, respectively). As such, management process 10 may be a stand-alone application that interfaces with a client application (e.g., client applications 22, 24, 26, 28), or may be applets/applications that may be executed within a client application. As such, management process 10 may be a client-side process, server-side process, or hybrid client-side/server-side process, which may be executed, in whole or in part, by server computer 12, or one or more of client electronic devices 38, 40, 42, 44.

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using client applications 22, 24, 26, 28, users 46, 48, 50, 52 may utilize the EDA to create an electronic design.

Users 46, 48, 50, 52 may access server application 20 directly through the device on which the client application (e.g., client applications 22, 24, 26, 28) is executed, namely client electronic devices 38, 40, 42, 44, for example. Users 46, 48, 50, 52 may access server application 20 directly through network 14 or through secondary network 18. Further, server computer 12 (e.g., the computer that executes server application 20) may be connected to network 14 through secondary network 18, as illustrated with phantom link line 54.

In some embodiments, management process 10 may be a cloud-based process as any or all of the operations described herein may occur, in whole, or in part, in the cloud or as part of a cloud-based system. The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (CSMA/CA) for path sharing. The various 802.11x specifications may use phase-shift keying (PSK) modulation or complementary code keying (CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, Apple iOS, ANDROID, or a custom operating system.

In some embodiments, management process 10 may include any or all of the features and operations described herein.

A bootstrap system may be required to instantiate the central primary management system. This system may be either a dedicated workstation computer with preloaded artifacts and applications or a temporary system hosted within the same regional or on-premises infrastructure provider as the primary management system. In the case of bootstrapping operations from a dedicated workstation, the bootstrapping process may include preloading the workstation with the utilities, libraries, and artifacts necessary to perform the initial infrastructure creation via IaC-based automation, and then securely transferring the appropriate infrastructure management API keys and/or credentials to the workstation.

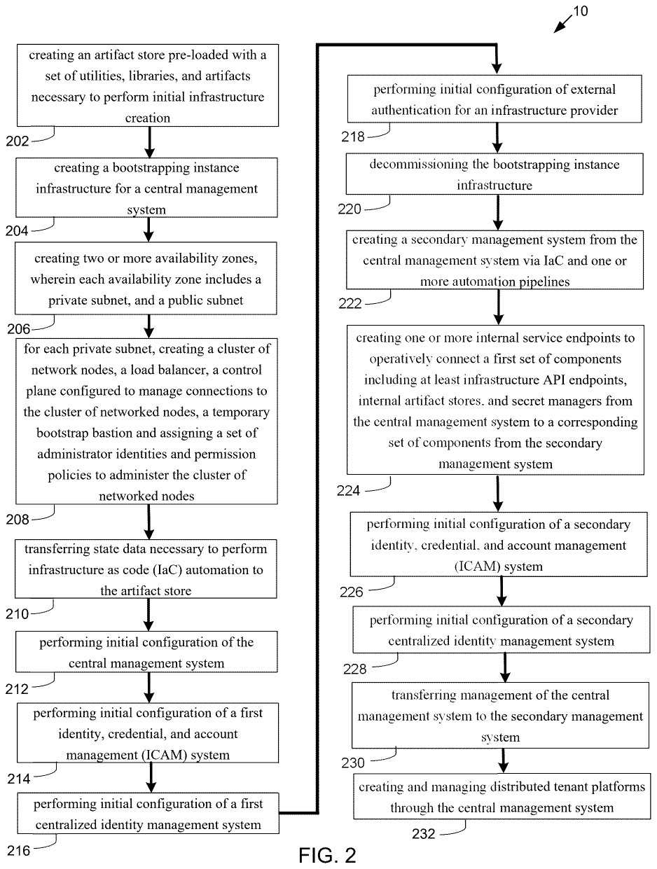

Referring now to FIG. 2, a flowchart of management process 10 illustrating how a bootstrap system may be used to instantiate a central primary management system consistent with embodiments of the present disclosure is provided. Management process 10 may start by creating (202) an artifact store pre-loaded with a set of utilities, libraries, and artifacts necessary to perform initial infrastructure creation in a local environment

Creating (204) a bootstrapping instance infrastructure for a central management system, and creating (206) two or more availability zones, where each availability zone includes a private subnet, and a public subnet. Management process 10 may further include creating (208), for each private subnet, a cluster of network nodes, a load balancer, a control plane configured to manage connections to the cluster of networked nodes, a temporary bootstrap bastion and assigning a set of administrator identities and permission policies to administer the cluster of networked nodes, transferring (210) state data necessary to perform infrastructure as code (IaC) automation to the artifact store, and performing (212) initial configuration of the central management system. Management process 10 may also include performing (214) initial configuration of a first identity, credential, and account management (ICAM) system, performing (216) initial configuration of a first centralized identity management system, performing (218) initial configuration of external authentication for an infrastructure provider, and decommissioning (220) the bootstrapping instance infrastructure. Management process 10 may then proceed by creating (222) a secondary management system from the central management system via IaC and one or more automation pipelines, creating (224) one or more internal service endpoints to operatively connect a first set of components including at least infrastructure API endpoints, internal artifact stores, and secret managers from the central management system to a corresponding set of components from the secondary management system, and performing (226) initial configuration of a secondary identity, credential, and account management (ICAM) system. Then management process 10 may conclude by performing (228) initial configuration of a secondary centralized identity management system, transferring (230) management of the central management system to the secondary management system, and creating (232) and managing distributed tenant platforms through the central management system.

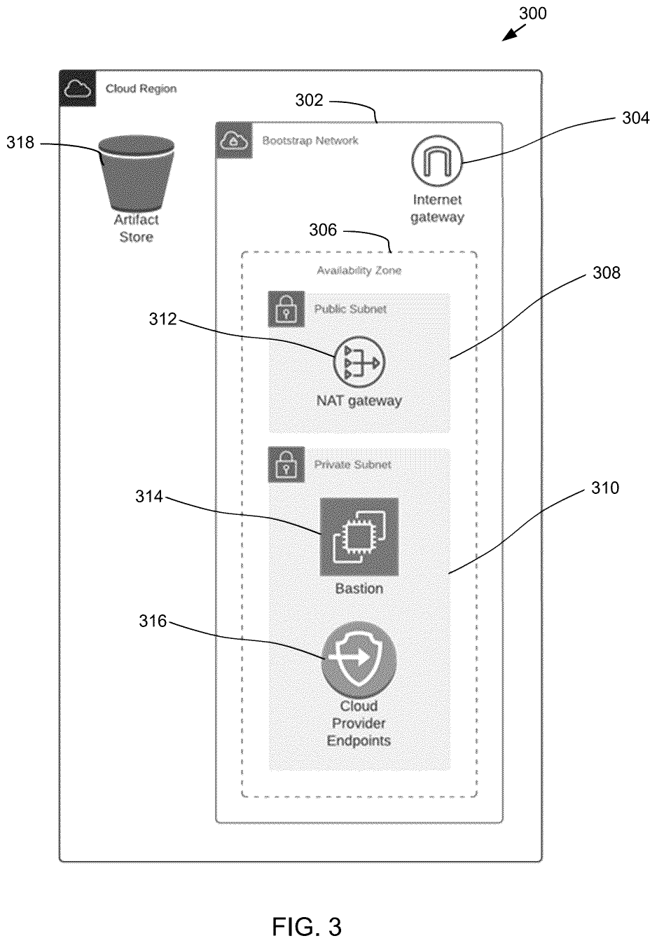

Referring now to FIG. 3, example 300 of a hosted infrastructure based bootstrap configuration consistent with embodiments of the present disclosure is provided. The hosted infrastructure based bootstrap configuration of example 300 may include a bootstrap network (e.g., bootstrap 302) hosted in a cloud region. Bootstrap 302 may further include a network gateway (e.g., gateway 304) and an availability zone (e.g., zone 306), where zone 308 may include a public subnet (e.g., public subnet 308) and a private subnet (e.g., private subnet 310). Public subnet 308 may also include a network address translation (NAT) gateway (e.g., NAT gateway 312) to enable instances in a subnet to access the internet, while preventing the internet from initiating connections back to those instances. Private subnet 310 may include a bastion (e.g., bastion 314) or a temporary or initial bastion host that may be used during the setup (“bootstrapping”) phase of infrastructure to provide secure administrative access to new or uninitialized systems. Private subnet 310 may also include cloud provider endpoints (e.g., endpoint 316), which may be network interfaces used to enable private and secure access to cloud provider services without using the public internet. The hosted infrastructure based bootstrap configuration of example 300 may also include an artifact store (e.g., artifact store 318), which may be a centralized storage location where build artifacts such as compiled code, packages, container images, and other output files from a build or continuous integration (CI) or continuous deployment (CD) pipeline may be stored, managed, and versioned.

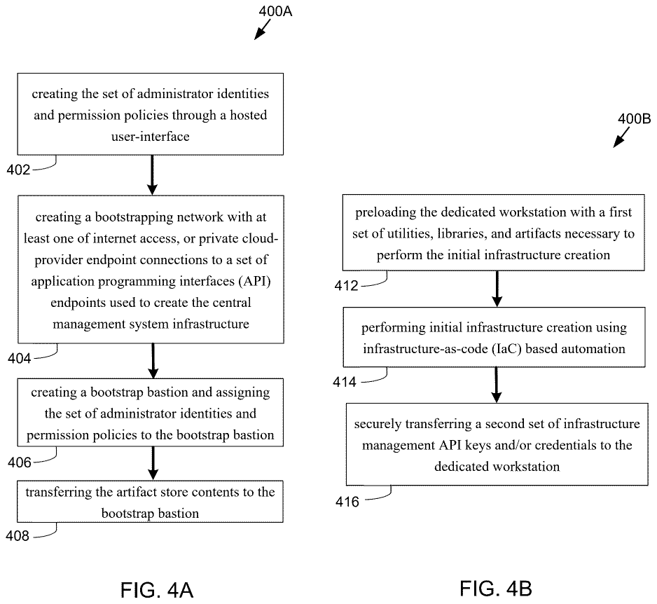

FIGS. 4A and 4B show example flowcharts 400A and 400B, outlining the bootstrapping process or the “creating (204) a bootstrapping instance infrastructure for a central management system” previously mentioned in the discussion of management process 10. Flowcharts 400A and 400B, may outline the bootstrapping process in different contexts. Flowchart 400A may consider the case of bootstrapping operations from a hosted infrastructure, as previously mentioned in the discussion of example 300 in FIG. 3, while flowchart 400B may consider the case of bootstrapping operations from a dedicated workstation (not shown). According to flowchart 400A, the infrastructure provider's hosted user interface may be used to perform a variety of initialization tasks, such as, creating (402) the bootstrapping identities and permission policies, creating (404) a bootstrapping network with internet access and/or private cloud-provider endpoint connections to the API endpoints used to create the central management system infrastructure, and creating (406) a bootstrap bastion and assigning it the identity and permissions needed to create the central management system infrastructure. The host-based bootstrapping process of flowchart 400A may further include transferring (408) the contents of the artifact store to the bootstrap bastion.

In some embodiments, bootstrapping operations may be executed from a dedicated workstation as described in flowchart 400B, in which case the act of “creating (204) a bootstrapping instance” in management process 10 may instead include preloading (412) the dedicated workstation with a first set of utilities, libraries, and artifacts necessary to perform the initial infrastructure creation, performing (414) initial infrastructure creation using infrastructure-as-code (IaC) based automation, and securely transferring (416) a second set of infrastructure management API keys and/or credentials to the dedicated workstation. In this context, “infrastructure-as-code (IaC) based automation” may refer to the practice of managing and provisioning IT infrastructure, such as servers, networks, databases, etc., using code rather than manual processes.

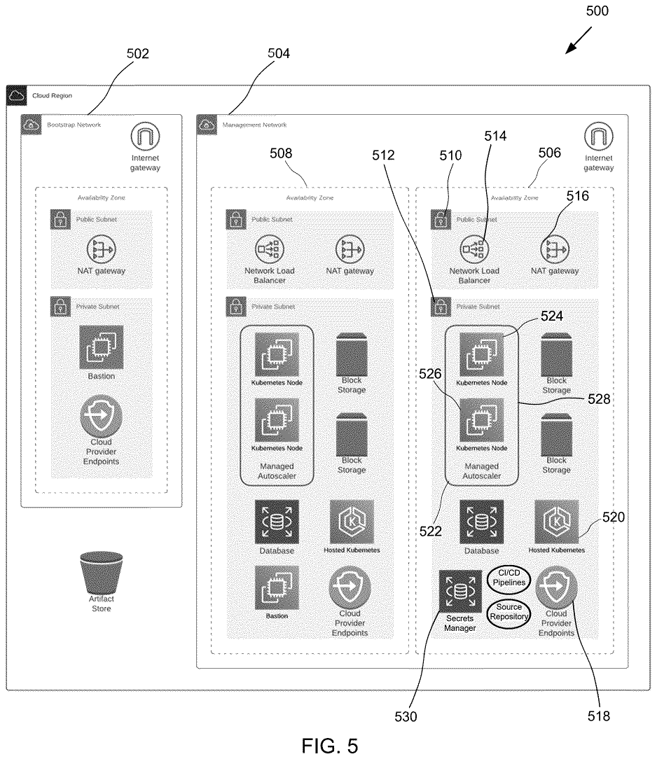

Referring now to FIG. 5, example 500 of an initiated central management system consistent with embodiments of the present disclosure is provided. The central management system infrastructure of example 500 may be the result of the bootstrapping process outlined in flowchart 400A. The central management system of example 500 may be hosted on a cloud region and include a bootstrapping network (e.g., bootstrap 502) and a management network (management network 504). Management network 504 may include two availability zones (e.g., zones 506, 508 respectively), such that each of zones 506, 508 may include public and private subnets. First zone 506 may include a public subnet (e.g., public subnet 510) and a private subnet (e.g., private subnet 512), where public subnet 510 may include a network load balancer (e.g., load balancer 514) to distribute incoming network traffic across multiple servers. Public subnet 510 may also include a NAT gateway (e.g., NAT gateway 516).

Private subnet 512 may include cloud provider endpoints (e.g., endpoint 518), such that endpoint 518, in conjunction with NAT gateway 516 may be configured to facilitate egress. Private subnet 512 may further include a hosted Kubernetes control plane (e.g., control plane 520) configured to manage the overall state of a cluster of Kubernetes nodes, make global decisions, and ensure that the desired state of applications may be maintained. Moreover, in this context, Kubernetes may refer to an open-source container orchestration platform designed to automate the deployment, scaling, and management of containerized applications. Private subnet 512 may also include managed autoscaling services (e.g., autoscaler 522) that may be configured to create and manage Kubernetes nodes (e.g., nodes 524, 526 respectively). Network load balancers may be created to manage ingress into the Kubernetes cluster. A temporary Kubernetes bastion (e.g., bastion 528) may also be created in private subnet 512 and assigned the necessary identity and permissions to administer the hosted Kubernetes cluster (nodes 524, 526). Second zone 508 may be similarly designed, such that both the public subnet and the private subnet mirror first zone 506 including an identical set of components.

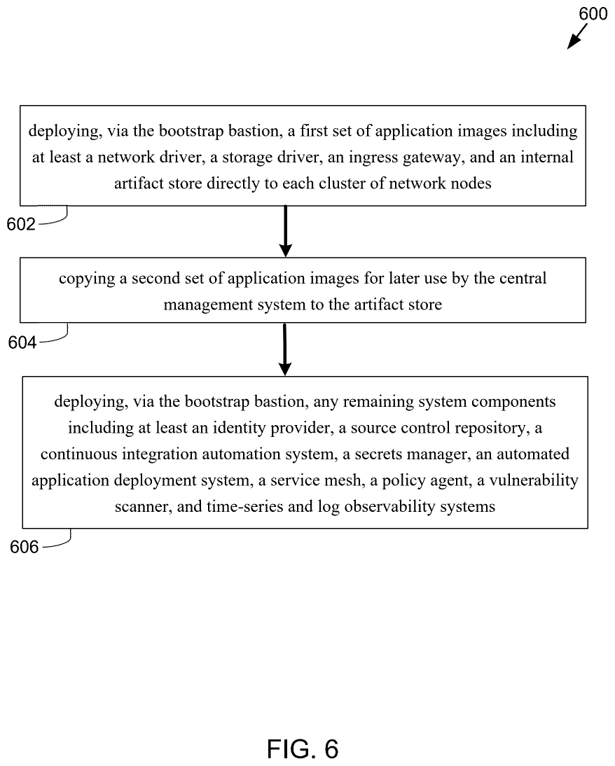

Referring now to FIGS. 2 and 6, where flowchart 600 may outline in greater detail the process of “performing (212) the initial configuration of the central management system” provided in management process 10. According to flowchart 600, initial configuration of the central management system may include deploying (602), via the bootstrap bastion, a first set of application images including at least a network driver, a storage driver, an ingress gateway, and an internal artifact store directly to each cluster of network nodes, copying (604) a second set of application images for later use by the central management system to the artifact store, and deploying (606), via the bootstrap bastion, any remaining system components including at least an identity provider, a source control repository, a continuous integration automation system, a secrets manager (e.g., secrets manager 530), an automated application deployment system, a service mesh, a policy agent, a vulnerability scanner, and time-series and log observability systems. In some embodiments, representations of secrets manager 530, repositories, and pipelines may be shown in private subnet 512. This placement may reflect the architectural design where these core management and automation components reside within the secure private subnet of the central management system. Secrets manager 530, source repository, and CI/CD Pipelines may be positioned together in private subnet 512 because they form an integrated automation workflow: the source repository may store the infrastructure-as-code definitions, the CI/CD pipelines may execute these definitions, and secrets manager 530 may provide the necessary credentials for pipeline execution. Placing these components in the private subnet may ensure that they are protected from direct internet access, while remaining accessible to Kubernetes nodes 524, 526 and management infrastructure within the same subnet. Example 500 may represent the central management system's core automation infrastructure, from which all distributed tenant platform deployments may be orchestrated. The components shown in the right-side availability zone may be replicated for high availability in the left-side zone, though only one instance is illustrated to maintain diagram clarity. Additionally, these components may be critically important to the centralized management system's ability to store credentials, maintain infrastructure code, and execute automated deployment pipelines.

In some embodiments, the initial configuration of the central management system may be performed from the Kubernetes bastion. Application images for the platform's network driver, storage driver, ingress gateway, and internal artifact store may be deployed directly to the Kubernetes nodes, and each of the respective workloads may be deployed and configured. The remaining application images used by the system may be copied to the internal artifact store, and the remaining system components may be deployed, including:
an identity provider, a source control repository, a continuous integration automation system, a secrets manager, an automated application deployment system, a service mesh, a policy agent, a vulnerability scanner, and time-series and log observability systems.

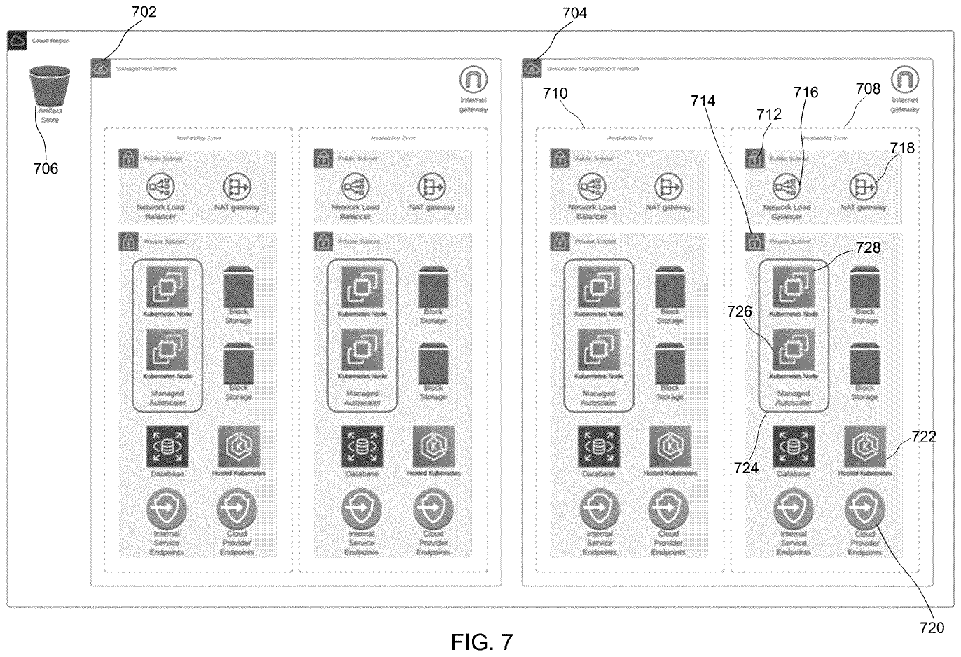

Referring now to FIG. 7, example 700 of an initiated central management system and a secondary management system consistent with embodiments of the present disclosure is provided. The combined central and secondary management system of example 700 may be hosted on a cloud region and include a management network (e.g., management network 702), a secondary network (e.g., secondary network 704), and an artifact store 706, where both management network 702 and secondary network 704 may be identically composed. Both networks include two availability zones, wherein each zone may include public and private subnets.

Secondary network 704 may include a first availability zone (e.g., first zone 708) and a second availability zone (e.g., second zone 710), such that first zone 708 and second zone 710 may also be identically composed. Between management network 702 and secondary network 704, the combined central and secondary management system of example 700 may include 4 identical availability zones. Each zone may include a public subnet (e.g., public subnet 712) and a private subnet (e.g., private subnet 714), where public subnet 712 may include a network load balancer (e.g., load balancer 716) to distribute incoming network traffic across multiple servers. Public subnet 712 may also include a NAT gateway (e.g., NAT gateway 718).

Private subnet 714 may include cloud provider endpoints (e.g., endpoint 720), such that endpoint 720, in conjunction with NAT gateway 718 may be configured to facilitate egress. Private subnet 714 may further include a hosted Kubernetes control plane (e.g., control plane 722) configured to manage the overall state of a cluster of Kubernetes nodes, make global decisions, and ensure that the desired state of applications may be maintained. Private subnet 714 may also include managed autoscaling services (e.g., autoscaler 724) that may be configured to create and manage Kubernetes nodes (e.g., nodes 726, 728 respectively). Network load balancers may be created to manage ingress into the Kubernetes cluster. At this point the temporary Kubernetes bastion (not shown) may have been decommissioned in private subnet 714 and all infrastructure as code (IaC), libraries, and tools may have already been transferred over to the artifact store.

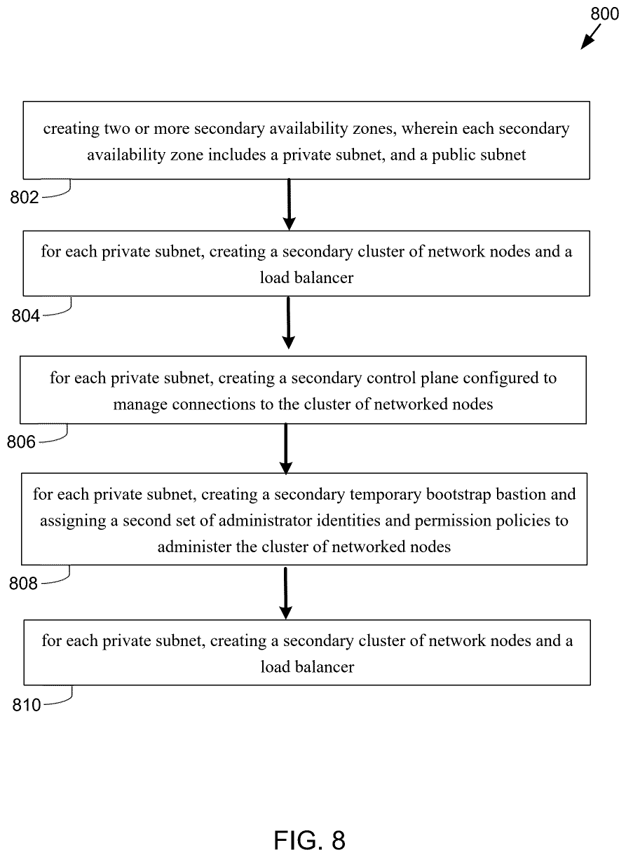

Referring now to FIGS. 2 and 8, where flowchart 800 may outline in greater detail the process of “creating (222) a secondary management system from the central management system via IaC and one or more automation pipelines” provided in management process 10. According to flowchart 800, the process of creating a secondary management system from the central management system may include creating (802) two or more secondary availability zones, wherein each secondary availability zone includes a private subnet, and a public subnet, creating(804) for each private subnet, a secondary cluster of network nodes and a load balancer, and creating (806) for each private subnet, a secondary control plane configured to manage connections to the cluster of networked nodes. The process of creating a secondary management system from the central management system may also include creating (808) for each private subnet, a secondary temporary bootstrap bastion and assigning a second set of administrator identities and permission policies to administer the cluster of networked nodes, and transferring (810) state data necessary to perform IaC automation to a secondary artifact store.

In some embodiments, once the secondary management system is created and configured, the management of the central management system, previously performed via manual processes performed from bastion systems, may be transferred to the secondary management system. The secondary management system's automated application deployment system may be configured to manage each of the central management system's subsystems, using images served by the secondary management system's internal artifact store and secrets provided by the central management system's secret manager. The infrastructure-as-code state for the central management system may be transferred to the secondary management system, and infrastructure pipelines may be created to automate all future infrastructure. At this stage, the central and secondary management systems may operate as a highly available pair, ensuring that the independent failure of either system may be repaired or recovered from the other system via auditable automation pipelines.

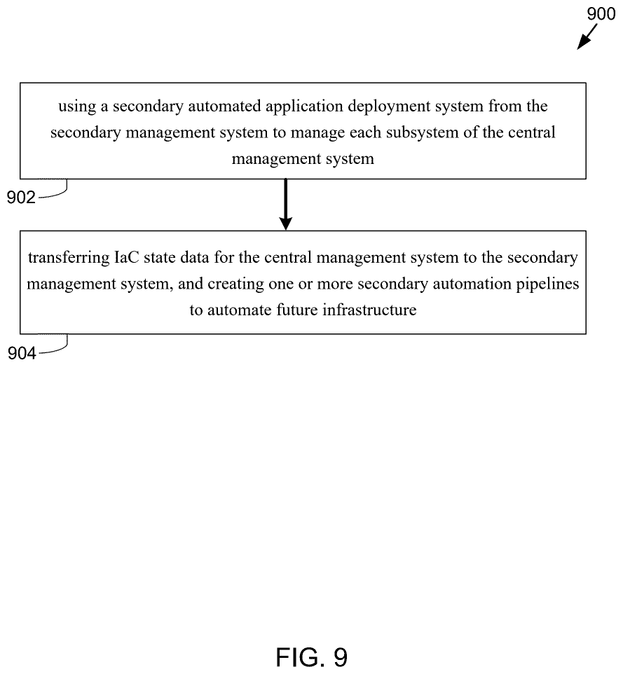

Referring now to FIGS. 2 and 9, where flowchart 900 may outline in greater detail the process of “transferring (230) management of the central management system to the secondary management system” provided in management process 10. According to flowchart 900, the process of transferring management of the central management system to the secondary management system may include using (902) a secondary automated application deployment system from the secondary management system to manage each subsystem of the central management system, and transferring (904) IaC state data for the central management system to the secondary management system, and creating one or more secondary automation pipelines to automate future infrastructure.

In some embodiments, the secondary management system's network and storage drivers, internal artifact store, identity provider, source control repository, continuous integration automation system, secrets manager, automated application deployment system, service mesh, policy agent, vulnerability scanner, and time-series and log observability systems may be deployed via the central management system's automated application deployment system, using images served by the central management system's internal artifact store and secrets provided by central management system's secret manager.

In some embodiments, the state data associated with the infrastructure-as-code (IaC) automation may be transferred to the artifact store, and the bootstrapping instance infrastructure may either be torn down (hosted infrastructure) or securely wiped (workstation). State data may essentially be a detailed record or “memory” of everything that Infrastructure-as-Code (IaC) tools have created and configured in a cloud environment. In other words, state data may be a comprehensive inventory list that keeps track of: (i) every resource created (servers, networks, databases, etc.), (ii) unique IDs assigned by the cloud provider, (iii) how each resource is configured, (iv) dependency relationships for each resource, and (v) the order in which the resources were created. This state data may come from the IaC tools (e.g., tools like: Terraform, CloudFormation, or Pulumi) when they first build the infrastructure. As these tools create each component by spinning up servers, setting up networks, configuring security rules, etc. the tools may record each action performed in a state-file. This state-file may act like a blueprint that shows a projected final schema, alongside the current state of the schema. The state data may be generated automatically as the IaC tools work, starting from the very first “terraform apply” or equivalent command. The state data may be updated every time a change is made to the infrastructure. Without this state data, the IaC tools may have no way of knowing what components have already been created, what components need to be updated, or how to deconstruct the bootstrap system safely without breaking dependencies. Before shutting down the bootstrap system that initially set everything up, this state data may be saved elsewhere (like in the artifact store) so future automation may continue managing the infrastructure without missing a step or losing track of what components have been created up to that point.

In some embodiments, the state data associated with the infrastructure-as-code automation may be transferred to the artifact store, and the bootstrapping instance infrastructure may either be torn down (hosted infrastructure) or securely wiped (workstation). The state data may include infrastructure configuration metadata that may track the current status and relationships of all provisioned resources within the managed environment. This state data may be generated during the initial infrastructure creation process, when IaC automation tools may provision resources such as networks, subnets, computer instances, storage volumes, and security policies. More specifically, the state data may include resource identifiers, configuration parameters, dependency mappings, and version tracking information that may enable the IaC automation system to maintain consistency between the desired infrastructure configuration and the actual deployed resources. During infrastructure provisioning, the IaC automation tools may generate and continuously update this state data to reflect resource creation, modification, and deletion operations. The state data may originate from the bootstrap bastion during initial setup and may subsequently be maintained by the automation pipelines, enabling infrastructure drift detection, resource lifecycle management, and automated rollback capabilities. Prior to decommissioning the bootstrap infrastructure, this critical state data may be securely transferred to ensure continuity of infrastructure management operations.

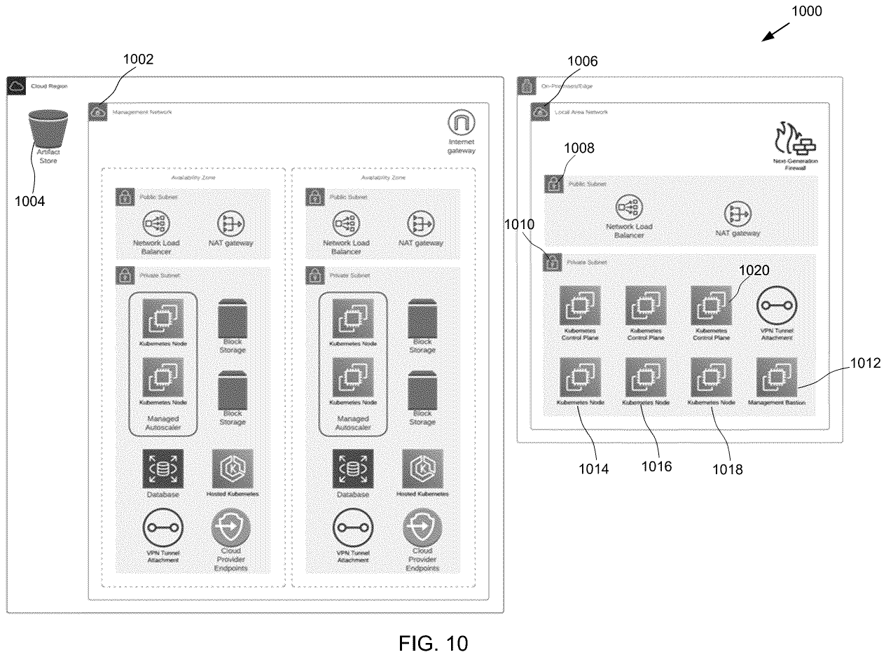

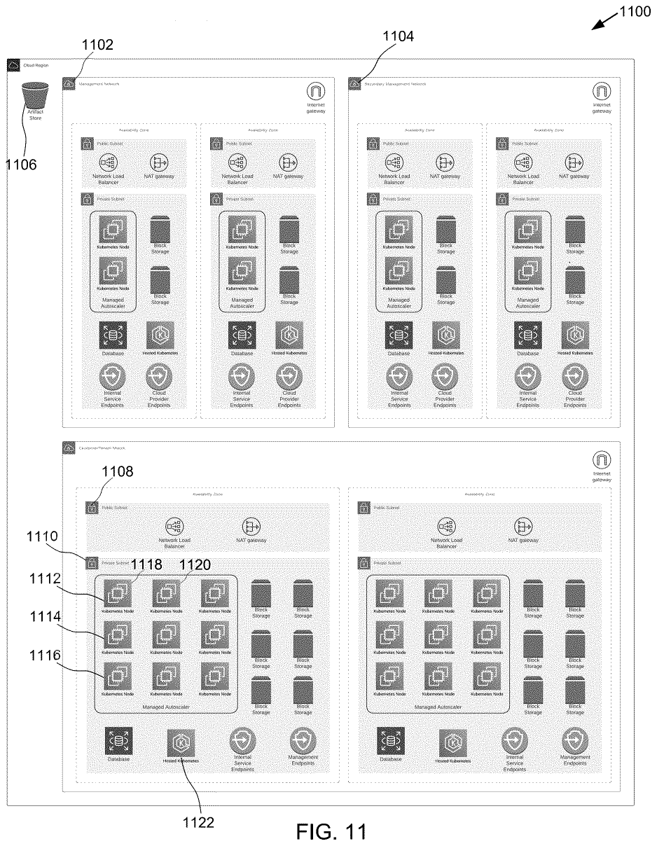

Referring now to FIGS. 10-11, example 1000 of an initiated central management system connected to an on-premises/Edge network, and example 1100 of a combined central management system and secondary management system connected to a customer/tenant network consistent with embodiments of the present disclosure are provided. Both examples, 1000, 1100, may represent instances where the central management system may provide a platform for creating and managing distributed tenant platforms. In example 1000 the central management system may be hosted on a cloud region and include a management network (e.g., management network 1002) and an artifact store (e.g., artifact store 1004) connected to a tenant's local area network (LAN) (e.g., LAN 1006) via virtual private network (VPN) tunnel. In example 1100, the combined central and secondary management system may also be hosted on a cloud region and include a management network (e.g., management network 1102), a secondary network (e.g., secondary network 1104), and an artifact store 1106, connected to a customer/tenant network that may also be hosted on the same cloud region. The tenant networks in both examples may include public and private subnets (e.g., public subnets 1008, 1108, and private subnets 1010, 1110, respectively).

In some embodiments, in example 1000, a management bastion (e.g., bastion 1012) may be created and configured as an agent of the central management system's continuous integration automation system. This bastion may be necessary in the on-premises/edge scenario to bridge the gap between the cloud-based management system and the physically separated tenant infrastructure. In contrast, example 1100 may depict a fully cloud-hosted scenario where both the management systems and the tenant network reside within the same cloud region. In this configuration, the management systems may directly interface with the tenant infrastructure through cloud-native networking and API endpoints, eliminating the need for a separate bastion host. The managed autoscalers shown in the tenant network of FIG. 11 may directly communicate with the central and secondary management systems through internal cloud provider networks, whereas the on-premises deployment in FIG. 10 may require the bastion to facilitate this communication across the VPN tunnel.

In some embodiments, identities and permission policies for managing tenant-location infrastructure may then be created and stored in the central management system's secrets manager. Infrastructure-as-code (IaC) repositories may be created in the central management system's source repository, and continuous integration pipelines may be created to apply the IaC in automated pipelines using credentials securely retrieved from the secrets manager. The integration pipelines may be executed from the agent on the management bastion, enabling the centralized management of edge infrastructure.

In some embodidments, each private subnet may further include a cluster of Kubernetes nodes (e.g., nodes 1014, 1016, 1018 in FIG. 10 and nodes 1112, 1114, 1116, 1118, 1120 in FIG. 11 respectively) and at least one hosted Kubernetes control plane (e.g., control plane 1020, 1122 respectively).

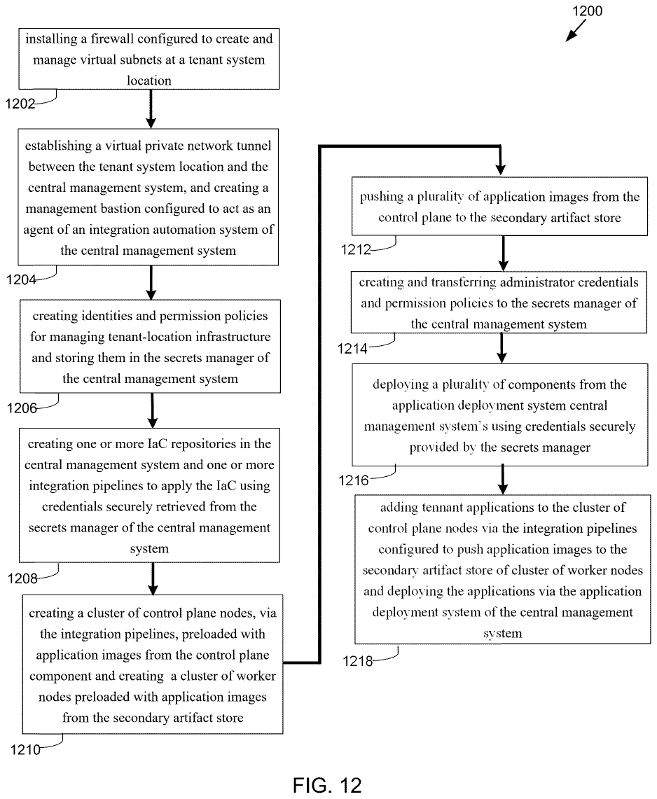

Referring now to FIGS. 2 and 12, where flowchart 1200 may outline in greater detail the process of “creating (232) and managing distributed tenant platforms through the central management system” provided in management process 10. According to flowchart 1200, the process of creating and managing distributed tenant platforms through the central management system may include installing (1202) a firewall configured to create and manage virtual subnets at a tenant system location, establishing (1204) a virtual private network tunnel between the tenant system location and the central management system, and creating a management bastion configured to act as an agent of an integration automation system of the central management system, and creating (1206) identities and permission policies for managing tenant-location infrastructure and storing them in the secrets manager of the central management system. The process of creating and managing distributed tenant platforms through the central management system may further include creating (1208) one or more IaC repositories in the central management system and one or more integration pipelines to apply the IaC using credentials securely retrieved from the secrets manager of the central management system, creating (1210) a cluster of control plane nodes, via the integration pipelines, preloaded with application images from the control plane component and creating a cluster of worker nodes preloaded with application images from the secondary artifact store, and pushing (1212) a plurality of application images from the control plane to the secondary artifact store. The process may also include creating (1214) and transferring administrator credentials and permission policies to the secrets manager of the central management system, deploying (1216) a plurality of components from the application deployment system central management system's using credentials securely provided by the secrets manager, and adding (1218) tenant applications to the cluster of control plane nodes via the integration pipelines configured to push application images to the secondary artifact store of cluster of worker nodes and deploying the applications via the application deployment system of the central management system.

In some embodiments, the infrastructure pipelines may create Kubernetes control plane nodes preloaded with the control plane components'application images and Kubernetes worker nodes preloaded with the network driver, storage driver, and internal artifact store application images. The control plane may be configured, and the worker nodes may be connected. Application images for an ingress gateway, service mesh, policy agent, vulnerability scanner, and time-series and log observability systems are pushed to the internal artifact system. Administrator credentials and policies may be configured and transferred to the central management system's secrets manager. The ingress gateway, service mesh, policy agent, vulnerability scanner, and time-series and log observability systems may be deployed to the tenant Kubernetes cluster from the central management system's automated deployment system (e.g., Kuberntes Control Plane) using credentials securely provided by the secrets manager.

In some embodiments, tenant applications may be added to the cluster via automated pipelines that push application images to the tenant cluster's internal artifact store and may deploy the applications via the central management system's automated deployment system. Once deployed, the tenant cluster and its applications may be operationally stable in the event of a loss of connectivity to the central management system.

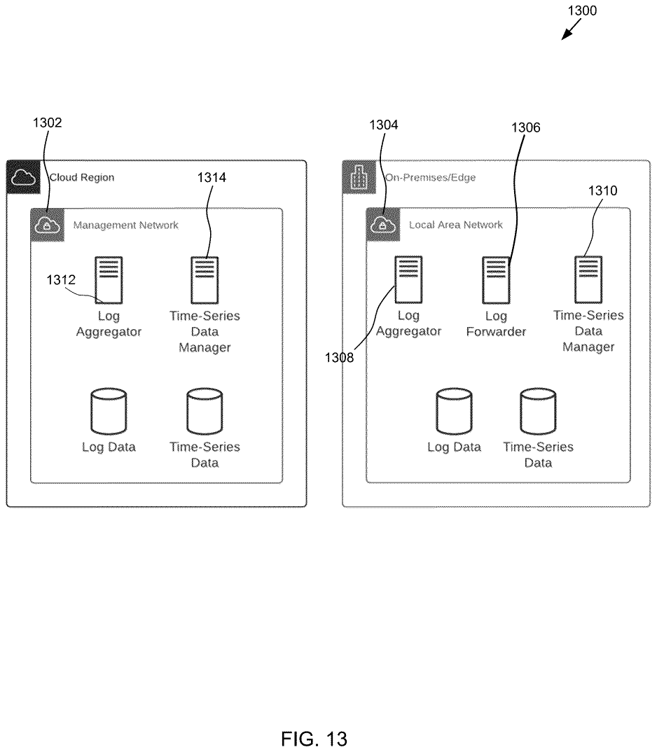

Referring now to FIG. 13, example 1300 of system/application logging tools consistent with embodiments of the present disclosure is provided. Each tenant cluster may provide co-located and centralized observability of application logs, audit logs, and time-series metrics data via inwardly cascading streams managed by log aggregators and time-series data managers at each tenant cluster and in the centralized management system. Example 1300 may show a management network (e.g., management network 1302) hosted on a cloud region alongside a central management system, and a local area network (e.g., LAN 1304) of the tenant's physical location. In use local log forwarders (e.g., log forwarder 1306) on each node in a Kubernetes cluster may collect application logs and forward them to a local aggregator (e.g., local aggregator 1308), applications may then push audit logs to local aggregator 1308, and time-series application metrics may be scraped from the logs by a local time-series data manager (e.g., local manager 1310). Log and time-series data may then be optionally filtered or sampled to reduce their total size and written to co-located data stores with automated lifecycle policies to ensure data remains stored in a manner consistent with organizational policy.

In some embodiments, application logs, time-series metrics, and audit logs may be optionally filtered or sampled and pushed to the central management system's log aggregator (e.g., central aggregator 1312) and time-series data manager (e.g., central manager 1314), to ensure that any successfully pushed/forwarded data may remain available even during periods of loss of connectivity. During periods of connectivity, the tenant log aggregator and time-series data manager may be remotely queried from the central management system, allowing full-resolution observability data on demand.

In some embodiments, the central management system's ICAM (identity, credential, and account management) subsystem may provide centralized user management for all tenant application platforms. The ICAM may may be stored within the database and secret manager 530. However, to enable user login to on-premises and edge tenant applications while disconnected from the central management system, an edge ICAM subsystem may be deployed to each cluster, and user accounts may be distributed. The users of each tenant platform, or group of closely related platforms, may be managed in a realm within the central ICAM subsystem. The Central ICAM may maintain a table of which version of each user account has been successfully synchronized to each edge ICAM. Each edge ICAM may initiate period synchronization requests to the central ICAM. Upon receiving a synchronization request, the central ICAM queries for records that may have been created, updated, or deleted since the edge ICAM instance's last synchronization request. As the edge ICAM instance processes each change, it may send an acknowledgment back to the central ICAM, which then updates its synchronization data. In this way, the central ICAM subsystem may provide a single point of access for all user account management for platform services and tenant applications while enabling (denied, degraded, intermittent, and limited) DDIL-resilient user authentication.

In some embodiments, when initially deployed, the ICAM (identity, credential, and account management) system may be configured to require mTLS (mutual transport layer security) connections with client certificates signed by an explicitly trusted PKI certificate authority. The initial administrator account may be configured with credentials provided to the ICAM workloads via the platform's secret management. Platform administrators may access the ICAM systems'web interface and authenticate with a trusted mTLS certificate (e.g., via a smartcard) and the administrator account credentials. The administrators may provision user-specific administrator accounts and then disable the built-in administrator user.

In some embodiments, during the initial configuration stage, all systems may be configured using built-in administrator credentials provided to the repository's workloads via the platform's secret management. After the ICAM system is configured, the built-in administrator account may be used to configure single sign-on via the ICAM system, and then the built-in administrator accounts may be disabled.

In some embodiments, when the infrastructure provider supports external authentication, the central management system's ICAM provider may be configured to provide authentication to engineers accessing the infrastructure provider's API endpoints and user interface. Additionally, the CI Automation and ICAM provider may be configured to allow automation pipelines to request short-lived credentials for the infrastructure provider, enabling secure automated management of infrastructure via auditable pipelines.

In some embodiments, before decommissioning the Kubernetes bastion, all infrastructure as code, libraries, and tools may be transferred to the source repository, artifact repository, or CI automation runners, enabling fully automated management of infrastructure and systems.

In some embodiments, the secondary management system's identity, credential, and account management may be configured following the same process used with the central management system, including the management of short-term infrastructure-provider credentials.

The terminology used herein is for the purpose of describing particular embodiments and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

Although a few example embodiments have been described in detail above, those skilled in the art will readily appreciate that many modifications are possible in the example embodiments without materially departing from the scope of the present disclosure, as described herein. Accordingly, such modifications are intended to be included within the scope of this disclosure as defined in the following claims. In the claims, means-plus-function clauses may cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail, and a screw may be equivalent structures. It is the express intention of the applicant not to invoke 35 U.S.C. § 112, paragraph (f) for any limitations of any of the claims herein, except for those in which the claim expressly uses the words ‘means for’ or ‘step for’ together with an associated function.

Having thus described the disclosure of the present application in detail and by reference to embodiments thereof, it will be apparent that modifications and variations are possible without departing from the scope of the disclosure defined in the appended claims.

What is claimed is:

1. A computer-implemented method for the centralized management of distributed intermittently connected runtime platforms, the method comprising:
creating an artifact store pre-loaded with a set of utilities, libraries, and artifacts necessary to perform initial infrastructure creation in a local environment;
creating a bootstrapping instance infrastructure for a central management system in the local environment;
creating two or more availability zones in the local environment, wherein each availability zone includes a private subnet and a public subnet;
for each private subnet, creating a cluster of network nodes, a load balancer, a control plane configured to manage connections to the cluster of network nodes, a temporary bootstrap bastion, and assigning a set of administrator identities and permission policies to administer the cluster of network nodes; and
transferring state data necessary to perform infrastructure as code (IaC) automation from the local environment to the artifact store.

2. The computer-implemented method of claim 1, further including:
performing initial configuration of the central management system;
creating a secondary management system, in the local environment, from the central management system via IaC and one or more automation pipelines;
transferring management of the central management system to the secondary management system; and
creating and managing distributed tenant platforms through the central management system.

3. The computer-implemented method of claim 1, wherein if the local environment is a hosted-server, then creating the bootstrapping instance infrastructure includes:
creating the set of administrator identities and permission policies through a hosted user-interface;
creating a bootstrapping network with at least one of internet access, or private cloud-provider endpoint connections to a set of application programming interfaces (API) endpoints used to create the central management system infrastructure;
creating a bootstrap bastion and assigning the set of administrator identities and permission policies to the bootstrap bastion; and
transferring the artifact store contents to the bootstrap bastion.

4. The computer-implemented method of claim 1, wherein if the bootstrapping instance infrastructure is created on a dedicated workstation, then creating the bootstrapping instance infrastructure includes:
preloading the dedicated workstation with a first set of utilities, libraries, and artifacts necessary to perform the initial infrastructure creation;
performing initial infrastructure creation using infrastructure-as-code (IaC) based automation; and
securely transferring a second set of infrastructure management API keys and/or credentials to the dedicated workstation.

5. The computer-implemented method of claim 1, wherein performing initial configuration of the central management system further includes:
deploying, via the bootstrap bastion, a first set of application images including at least a network driver, a storage driver, an ingress gateway, and an internal artifact store directly to each cluster of network nodes;
copying a second set of application images for later use by the central management system to the artifact store; and
deploying, via the bootstrap bastion, any remaining system components, including at least an identity provider, a source control repository, a continuous integration automation system, a secrets manager, an automated application deployment system, a service mesh, a policy agent, a vulnerability scanner, and time-series and log observability systems.

6. The computer-implemented method of claim 1, further including:
performing initial configuration of a first identity, credential, and account management (ICAM) system;
performing initial configuration of a first centralized identity management system;
performing initial configuration of external authentication for an infrastructure provider; and
decommissioning the bootstrapping instance infrastructure.

7. The computer-implemented method of claim 6, wherein the ICAM system is configured to initially require mutual transport layer security (mTLS) connections, including client certificates signed by a trusted certificate authority, before allowing access, and a built-in administrator account is initially provided to the ICAM by a secret management system.

8. The computer-implemented method of claim 7, wherein, during initial configuration, all systems are configured using the built-in administrator credentials provided via the secret management system, wherein after the ICAM system is configured, the built-in administrator account is configured to setup single sign-on access via the ICAM system and then the built-in administrator accounts are disabled.

9. The computer-implemented method of claim 6, wherein the ICAM system is configured to provide authentication access to an infrastructure's API endpoints and user interface.

10. The computer-implemented method of claim 6, wherein the ICAM system is configured to allow automation pipelines requesting temporary credentials for the infrastructure provider to enable secure automated management of infrastructure via the automation pipelines.

11. The computer-implemented method of claim 6, wherein before decommissioning the bootstrap bastion all infrastructure as code (IaC), libraries, and tools are transferred over to the artifact store before decommissioning the bootstrap bastion.

12. The computer-implemented method of claim 2, wherein creating a secondary management system from the central management system further includes:
creating two or more secondary availability zones, wherein each secondary availability zone includes a private subnet and a public subnet;
for each private subnet, creating a secondary cluster of network nodes and a load balancer;
for each private subnet, creating a secondary control plane configured to manage connections to the cluster of network nodes;
for each private subnet, creating a secondary temporary bootstrap bastion and assigning a second set of administrator identities and permission policies to administer the cluster of network nodes;
transferring state data necessary to perform IaC automation to a secondary artifact store.

13. The computer-implemented method of claim 1, further including:
creating one or more internal service endpoints to operatively connect a first set of components from the central management system, including at least infrastructure API endpoints, artifact stores, and secret managers, to a corresponding set of components in the secondary management system;
performing initial configuration of a secondary identity, credential, and account management (ICAM) system; and
performing initial configuration of a secondary centralized identity management system.

14. The computer-implemented method of claim 13, wherein application images for the secondary management system are deployed via the automated application deployment system of the central management system, and wherein the images served by the artifact store of the central management system are provided by the secret manager of the central management system.

15. The computer-implemented method of claim 13, wherein after the secondary ICAM system is configured, a built-in administrator account is used to configure single sign-on via the secondary ICAM system, and then the built-in administrator accounts are disabled.

16. The computer-implemented method of claim 14, wherein transferring management of the central management system to the secondary management system includes:
using a secondary automated application deployment system from the secondary management system to manage each subsystem of the central management system;
transferring IaC state data for the central management system to the secondary management system, and creating one or more secondary automation pipelines to automate future infrastructure.

17. The computer-implemented method of claim 2, wherein creating and managing distributed tenant platforms through the central management system includes:
installing a firewall configured to create and manage virtual subnets at a tenant system location;
establishing a virtual private network tunnel between the tenant system location and the central management system, and creating a management bastion configured to act as an agent of an integration automation system of the central management system;
creating identities and permission policies for managing tenant-location infrastructure and storing them in the secrets manager of the central management system;
creating one or more IaC repositories in the central management system and one or more integration pipelines to apply the IaC using credentials securely retrieved from the secrets manager of the central management system;
creating a cluster of control plane nodes, via the integration pipelines, preloaded with application images from the control plane component, and creating a cluster of worker nodes preloaded with application images from the secondary artifact store;
pushing a plurality of application images from the control plane to the secondary artifact store;
creating and transferring administrator credentials and permission policies to the secrets manager of the central management system;
deploying a plurality of components from the application deployment system to the central management system using credentials securely provided by the secrets manager; and
adding tenant applications to the cluster of control plane nodes via the integration pipelines configured to push application images to the secondary artifact store of cluster or worker nodes, and deploying the applications via the application deployment system of the central management system.

18. The computer-implemented method of claim 17, wherein the integration pipelines are executed from an agent on the management bastion to enable the centralized management of edge infrastructure.

19. A centralized management system for distributed intermittently connected runtime platforms system comprising:
an artifact store pre-loaded with a set of utilities, libraries, and artifacts necessary to perform initial infrastructure creation;
a primary management system deployed on a hosted server, and configured to manage and control a plurality of runtime platforms, wherein the primary management system includes two or more availability zones, and each availability zone includes a private subnet and a public subnet; and
a secondary management system operatively connected to the primary management system, and configured to manage and control the primary management system, wherein the secondary management system is further configured to ensure continuity of command and control in the event of a loss or disruption of the primary management system, wherein the secondary management system is configured to recover and replace the primary management system via autonomous methods and automated routines.

20. The centralized management system of claim 19, wherein the primary management system is further configured to:
store and execute automated routines that create, initialize, and monitor platform infrastructure for one or more connected runtime platforms; and
deploy, initialize, and monitor a combination of services, tenant applications and security systems hosted on the one or more runtime platforms.
